(19) United States
(12) Patent Application Publication
(10) Pub. No.: US 2011/0194846 A1
(43) Pub. Date: Aug. 11, 2011

(54) FLUID HEATER

(75) Inventors: JIA-PING WANG, Beijing (CN); RUI XIE, Beijing (CN); KAI-LI JIANG, Beijing (CN); SHOU-SHAN FAN, Beijing (CN)

(73) Assignees: TSINGHUA UNIVERSITY, Beijing (CN); HON HAI PRECISION INDUSTRY CO., LTD., Tu-Cheng (TW)

(21) Appl. No.: 12/903,530

(22) Filed: Oct. 13, 2010

(30) Foreign Application Priority Data
Feb. 8, 2010 (CN) 201010111807.4

(51) Int. Cl. F24H 1/12; B82Y 99/00

(52) U.S. Cl. 392/482; 977/742

(57) ABSTRACT

A fluid heater includes an inner pipe and an outer pipe. The outer pipe surrounds the periphery of the inner pipe and is located separate from the inner pipe. The fluid heater further includes two sealed elements located apart from each other and between the inner pipe and the outer pipe. The inner pipe, the outer pipe and the two sealed elements define a sealed room. A heating module is located in the sealed room.

### RELATED APPLICATIONS

This application claims all benefits accruing under 35 U.S.C. §119 from China Patent Application No. 201010111807.4, filed on Feb. 8, 2010 in the China Intellectual Property Office, the contents of which are hereby incorporated by reference. The application is also related to copending application entitled, “HEATING PIPE”, filed ______ (Atty. Docket No. US30479).

### BACKGROUND

1. Technical Field

The present disclosure generally relates to a fluid heater.

2. Description of Related Art

In everyday life, industry, or science research, a heating fluid is needed. Heaters for fluid are often used to heat fluid, such as liquid or gas.

A conventional fluid heater includes an inner pipe and an outer pipe surrounding the inner pipe. The inner pipe and the outer pipe define a cavity. Heating wires are located in the inner pipe. In use, the conventional fluid heater is fixed at one end of a fluid pipe. The fluid flowing in the fluid pipe will be guided in the cavity of the fluid heater and heated by the heating wires in the inner pipe. However, because the fluid flows in the cavity, the heat of the fluid will be conducted from the outer pipe to outside, and the heating efficiency of the fluid heater will be adversely affected. As such, the fluid heater has a low heating efficiency. Furthermore, because the heater for the liquid is fixed on the end of the liquid pipe, it is difficult to heat other portions of the liquid pipe, and it is inconvenient to use the fluid heater.

What is needed, therefore, is a fluid heater that can overcome the above-described shortcomings.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of one embodiment of a fluid heater.

FIG. 2 is a cross-sectional view, along a line II-II of FIG. 1.

FIG. 3 is a Scanning Electron Microscope (SEM) image of a drawn carbon nanotube film.

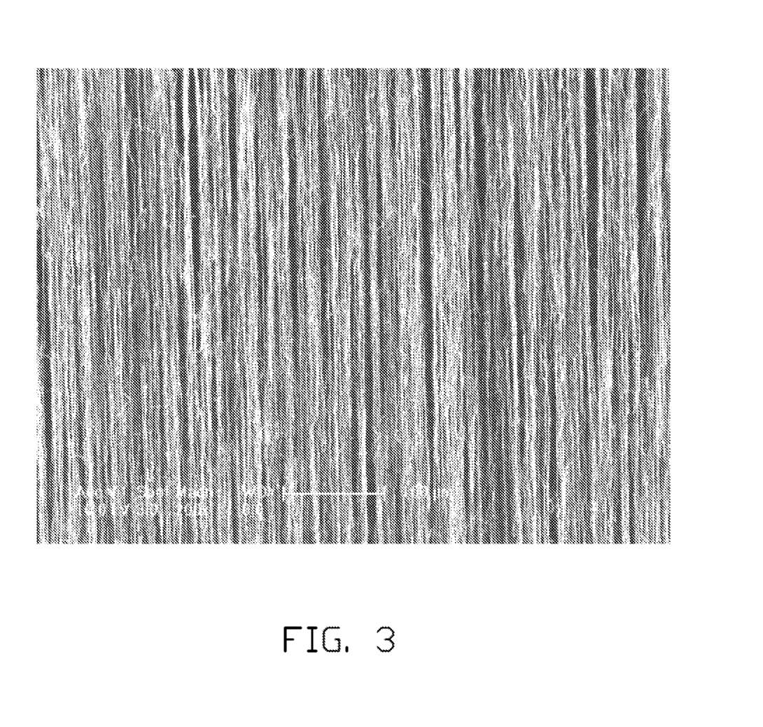

FIG. 4 is a schematic view of carbon nanotube segments in FIG. 3.

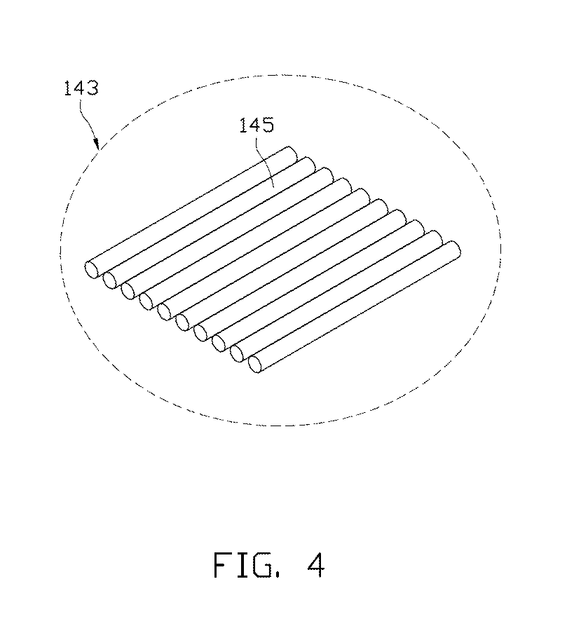

FIG. 5 is an SEM image of an untwisted carbon nanotube wire.

FIG. 6 is an SEM image of a twisted carbon nanotube wire.

FIG. 7 is an isometric view of the fluid heater of FIG. 1 with electrodes winding around an outer surface of an inner pipe.

FIG. 8 is an isometric view of another embodiment of a fluid heater.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

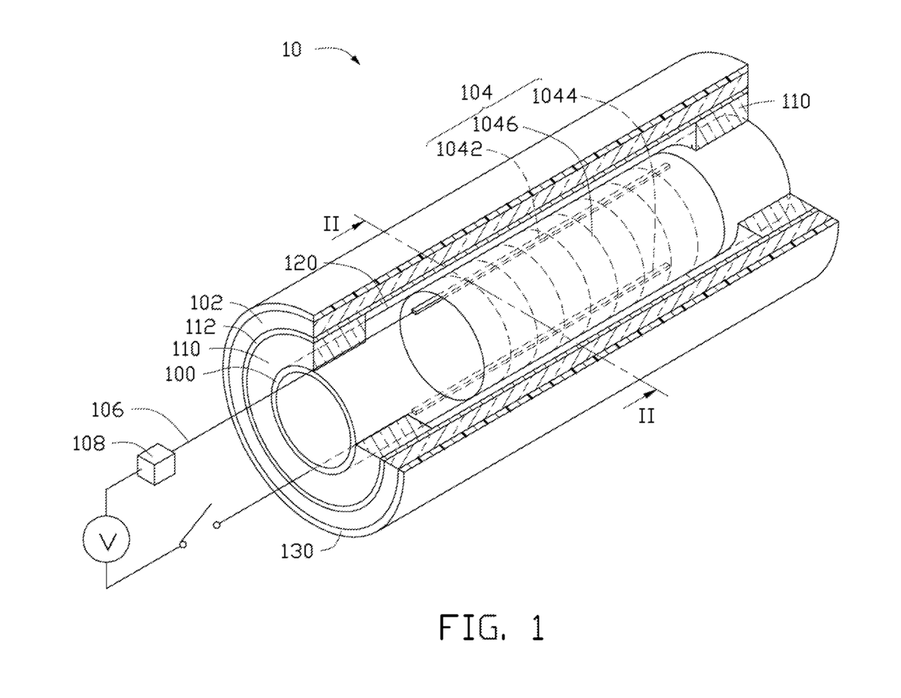

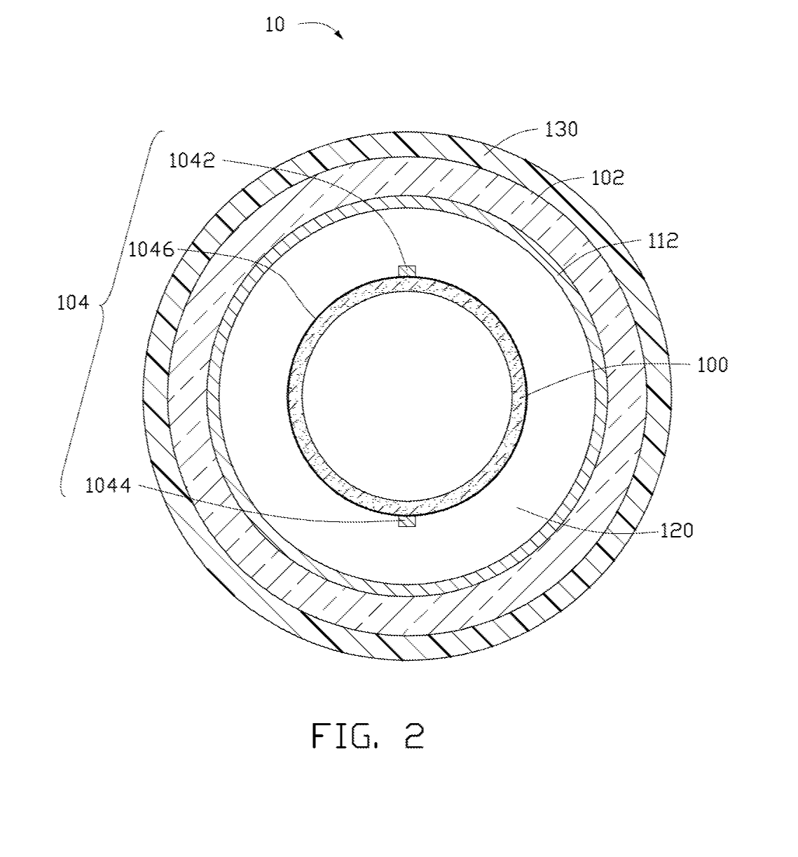

Referring to FIGS. 1 and 2, a fluid heater 10 of one embodiment is shown. The fluid heater 10 includes an inner pipe 100, an outer pipe 102 surrounding the inner pipe 100, two sealed elements 110 located on an outer surface of the inner pipe 100, and a heating module 104 located between the inner pipe 100 and the outer pipe 102. The two sealed elements 110 contact two ends of the outer pipe 102, and are located between the inner pipe 100 and the outer pipe 102. The inner pipe 100, the two sealed elements 110, and the outer pipe 102 cooperatively define a sealed room 120.

The inner pipe 100 encircles and is located on an outer surface of a conventional fluid pipe. A cross sectional shape of the inner pipe 100 can be round, square, triangular, or elliptical, depending on the shape of the conventional fluid pipe. A material of the inner pipe 100 can be dielectric materials, such as glass, ceramic, polymer, resin, or quartz. The inner pipe 100 can also be made of conductive materials coated with dielectric materials. The length and the diameter of the inner pipe 100 are not limited, and can be determined according to the conventional fluid pipe, which the fluid heater 10 will encircle. In one embodiment, the inner pipe 100 has a cylindrical shape with an outer diameter of about 5.12 millimeters and a wall thickness of about 1.15 millimeters.

The heating module 104 can be located on an outer surface of the inner pipe 100 or on an inner surface of the outer pipe 102. In this embodiment, the heating module 104 is located on the outer surface of the inner pipe 100 and is apart from the inner surface of the outer pipe 102. The heating module 100 includes a heating element 1046, a first electrode 1042, and a second electrode 1044. The first electrode 1042 and the second electrode 1044 are electrically connected with the heating element 1046. The heating element 1046 is positioned on the outer surface of the inner pipe 100 with adhesive or mechanical method. The first electrode 1042 and the second electrode 1044 can be located on a same surface or different surfaces of the heating element 1046. In one embodiment according to FIG. 1, the first electrode 1042 and the second electrode 1044 are positioned on the same surface of the heating element 1046. The first electrode 1042 and the second electrode 1044 can be electrically connected with the circuit system with at least two lead wires (not shown).

The heating element 1046 can be metal wires, metal alloy wires, carbon fibers, or carbon nanotube structures. The carbon nanotube structure can be formed by screen printing method. The carbon nanotube structure can be a freestanding structure, namely, the carbon nanotube structure can be supported by itself without a substrate. For example, if at least one point of the carbon nanotube structure is held, the entire carbon nanotube structure can be lifted without being destroyed. The carbon nanotube structure includes a plurality of carbon nanotubes joined by Van der Waals attractive force therebetween. The carbon nanotube structure can be a substantially pure structure of the carbon nanotubes, with few impurities. The carbon nanotubes can be used to form many different structures and provide a large specific surface area. The heat capacity per unit area of the carbon nanotube structure can be less than 2×10⁻⁴ J/m²*K. In one embodiment, the heat capacity per unit area of the carbon nanotube structure is less than or equal to 1.7×10⁻⁶ J/m²*K. Because the heat capacity of the carbon nanotube structure is very low, the temperature of the heating element 1046 can rise and fall quickly, and has a high response heating speed. Thus, the heating element 1046 has a high heating efficiency and accuracy. In addition, because the carbon nanotube structure can be substantially pure, the carbon nanotubes are not easily oxidized and the lifespan of the heating element 1046 will be relatively long. Furthermore, the carbon nanotube structure can have a small size, and the sealed room 120 can also be small. As such, the fluid heater will have an equally small size. Additionally, because the carbon nanotubes have a low density, about 1.35 g/cm³, the heating element 1046 is light. Because the carbon nanotube has a large specific surface area, the carbon nanotube structure with a plurality of carbon nanotubes has a larger specific surface area. If the specific surface of the carbon nanotube structure is large enough, the carbon nanotube structure is adhesive and can be directly applied to a surface.

The carbon nanotubes in the carbon nanotube structure can be orderly or disorderly arranged. The term ‘disorderly carbon nanotube structure’ refers to a structure where the carbon nanotubes are arranged along different directions, and the aligning directions of the carbon nanotubes are random. The number of the carbon nanotubes arranged along each different direction can be almost the same (e.g. uniformly disordered). The disorderly carbon nanotube structure can be isotropic, namely the carbon nanotube structure has properties identical in all directions of the carbon nanotube structure. The carbon nanotubes in the disorderly carbon nanotube structure can be entangled with each other.

The term ‘orderly carbon nanotube structure’ refers to a structure where the carbon nanotubes are arranged in a consistently systematic manner, e.g., the carbon nanotubes are arranged approximately along a same direction and/or have two or more sections within each of which the carbon nanotubes are arranged approximately along a same direction (different sections can have different directions). The carbon nanotubes in the carbon nanotube structure can be selected from single-walled, double-walled, and/or multi-walled carbon nanotubes.

The carbon nanotube structure can be a layer carbon nanotube structure, a linear carbon nanotube structure or combinations thereof. If the carbon nanotube structure is a layer structure, the carbon nanotube structure can wrap the outer surface of the inner pipe 100. If the carbon nanotube structure includes a single linear carbon nanotube structure, the single linear carbon nanotube structure can spirally twist about the inner pipe 100. If the heating element 1046 includes two or more linear carbon nanotube structures, the linear carbon nanotube structures can be located on the outer surface of the inner pipe 100 and be substantially parallel with each other. The linear carbon nanotube structures can be located side by side or separately. If the carbon nanotube structure includes a plurality of linear carbon nanotube structures, the linear carbon nanotube structures can be knitted to obtain a net structure located on the outer surface of the inner pipe 100.

The carbon nanotube structure with layer structure includes at least one carbon nanotube film. In one embodiment, the carbon nanotube film is a drawn carbon nanotube film. A film can be drawn from a carbon nanotube array, to obtain a drawn carbon nanotube film. The drawn carbon nanotube film includes a plurality of successive and oriented carbon nanotubes joined end-to-end by Van der Waals attractive force therebetween. The drawn carbon nanotube film is a free-standing film. Each drawn carbon nanotube film includes a plurality of successively oriented carbon nanotube segments joined end-to-end by Van der Waals attractive force therebetween. Each carbon nanotube segment includes a plurality of carbon nanotubes substantially parallel to each other, and joined by Van der Waals attractive force therebetween. Some variations can occur in the drawn carbon nanotube film. The carbon nanotubes in the drawn carbon nanotube film are oriented along a preferred orientation. The carbon nanotube film can be treated with an organic solvent to increase the mechanical strength and toughness of the carbon nanotube film and reduce the coefficient of friction of the carbon nanotube film. The thickness of the carbon nanotube film can range from about 0.5 nm to about 100 μm.

The carbon nanotube structure of the heating element 1046 can include at least two stacked carbon nanotube films. In other embodiments, the carbon nanotube structure can include two or more coplanar carbon nanotube films, and can include layers of coplanar carbon nanotube films. Additionally, if the carbon nanotubes in the carbon nanotube film are aligned along one preferred orientation (e.g., the drawn carbon nanotube film) an angle can exist between the orientations of carbon nanotubes in adjacent films, whether stacked or adjacent. Adjacent carbon nanotube films can be joined by only the Van der Waals attractive force therebetween. The number of the layers of the carbon nanotube films is not limited. However, the thicker the carbon nanotube structure, the smaller the specific surface area. An angle between the aligned directions of the carbon nanotubes in two adjacent carbon nanotube films can range from about 0 degrees to about 90 degrees. If the angle between the aligned directions of the carbon nanotubes in adjacent carbon nanotube films is larger than 0 degrees, the carbon nanotubes in the heating element 1046 define a microporous structure. The carbon nanotube structure in an embodiment employing these films will have a plurality of micropores. Stacking the carbon nanotube films will also add to the structural integrity of the carbon nanotube structure.

In other embodiments, the carbon nanotube film can be a flocculated carbon nanotube film. The flocculated carbon nanotube film can include a plurality of long, curved, disordered carbon nanotubes entangled with each other. Furthermore, the flocculated carbon nanotube film can be isotropic. The carbon nanotubes can be substantially uniformly dispersed in the carbon nanotube film. Adjacent carbon nanotubes are acted upon by Van der Waals attractive force to obtain an entangled structure with micropores defined therein. It is noteworthy that the flocculated carbon nanotube film is very porous. Sizes of the micropores can be less than 10 μm. The porous nature of the flocculated carbon nanotube film will increase the specific surface area of the carbon nanotube structure. Further, due to the carbon nanotubes in the carbon nanotube structure being entangled with each other, the carbon nanotube structure employing the flocculated carbon nanotube film has excellent durability, and can be fashioned into desired shapes with a low risk to the integrity of the carbon nanotube structure. The thickness of the flocculated carbon nanotube film can range from about 0.5 nm to about 1 mm.

In other embodiments, the carbon nanotube film can be a pressed carbon nanotube film. The pressed carbon nanotube film can be a free-standing carbon nanotube film. The carbon nanotubes in the pressed carbon nanotube film are arranged along a same direction or along different directions. The carbon nanotubes in the pressed carbon nanotube film can rest upon each other. Adjacent carbon nanotubes are attracted to each other and are joined by Van der Waals attractive force. An angle between a primary alignment direction of the carbon nanotubes and a surface of the pressed carbon nanotube film is about 0 degrees to approximately 15 degrees. The greater the pressure applied, the smaller the angle obtained. If the carbon nanotubes in the pressed carbon nanotube film are arranged along different directions, the carbon nanotube structure can be isotropic. Here, “isotropic” means the carbon nanotube film has properties identical in all directions substantially parallel to a surface of the carbon nanotube film. The thickness of the pressed carbon nanotube film ranges from about 0.5 nm to about 1 mm.

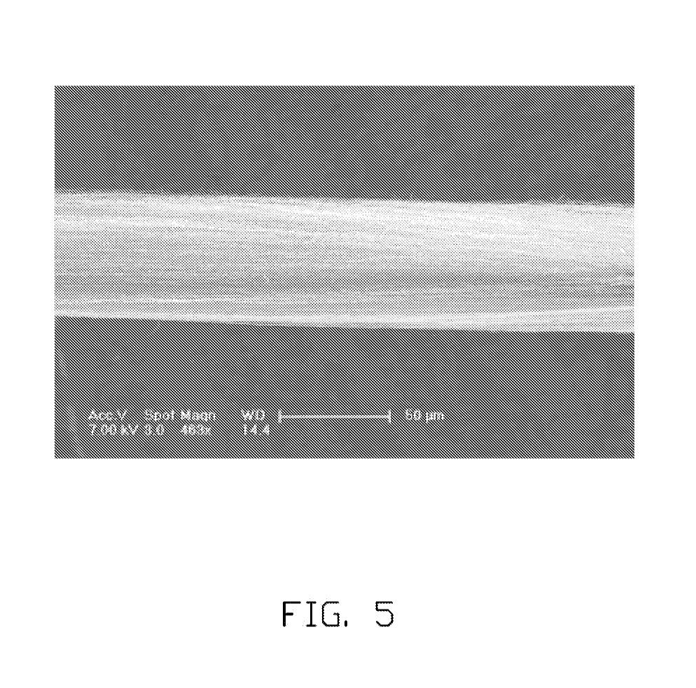

The linear carbon nanotube structure includes at least one carbon nanotube wire. The carbon nanotube wire can be untwisted or twisted. Treating the drawn carbon nanotube film with a volatile organic solvent can obtain the untwisted carbon nanotube wire. In one embodiment, the organic solvent is applied to soak the entire surface of the drawn carbon nanotube film. During the soaking, adjacent parallel carbon nanotubes in the drawn carbon nanotube film will bundle together, due to the surface tension of the organic solvent as it volatilizes, and thus, the drawn carbon nanotube film will be shrunk into an untwisted carbon nanotube wire. Referring to FIG. 5, the untwisted carbon nanotube wire includes a plurality of carbon nanotubes substantially oriented along a same direction (i.e., a direction along the length direction of the untwisted carbon nanotube wire). The carbon nanotubes are substantially parallel to the axis of the untwisted carbon nanotube wire. In one embodiment, the untwisted carbon nanotube wire includes a plurality of successive carbon nanotube segments joined end to end by Van der Waals attractive force therebetween. Each carbon nanotube segment includes a plurality of carbon nanotubes substantially parallel to each other, and combined by Van der Waals attractive force therebetween. The carbon nanotube segments can vary in width, thickness, uniformity and shape. The length of the untwisted carbon nanotube wire can be arbitrarily set as desired. A diameter of the untwisted carbon nanotube wire ranges from about 0.5 nm to about 100 μm.

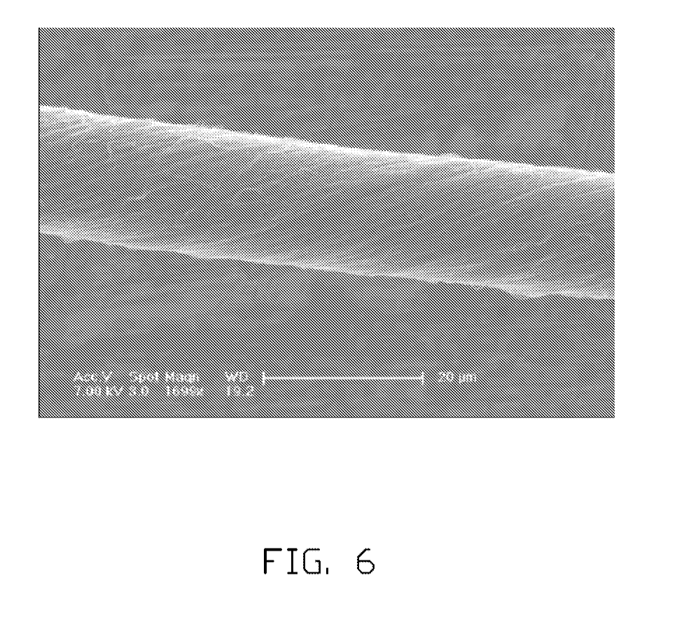

The twisted carbon nanotube wire can be obtained by twisting a drawn carbon nanotube film using a mechanical force to turn the two ends of the drawn carbon nanotube film in opposite directions. Referring to FIG. 6, the twisted carbon nanotube wire includes a plurality of carbon nanotubes helically oriented around an axial direction of the twisted carbon nanotube wire. In one embodiment, the twisted carbon nanotube wire includes a plurality of successive carbon nanotube segments joined end to end by Van der Waals attractive force therebetween. Each carbon nanotube segment includes a plurality of carbon nanotubes substantially parallel to each other, and combined by Van der Waals attractive force therebetween. The length of the carbon nanotube wire can be set as desired. A diameter of the twisted carbon nanotube wire can be from about 0.5 nm to about 100 μm. Further, the twisted carbon nanotube wire can be treated with a volatile organic solvent after being twisted. After being soaked by the organic solvent, the adjacent paralleled carbon nanotubes in the twisted carbon nanotube wire will bundle together, due to the surface tension of the organic solvent when the organic solvent volatilizes. The specific surface area of the twisted carbon nanotube wire will decrease, while the density and strength of the twisted carbon nanotube wire will be increased.

The heating element 1046 can be a carbon nanotube composite structure. The carbon nanotube composite structure includes the carbon nanotube structure disclosed above and matrix materials. The matrix materials are filled in the carbon nanotube structure or located on at least one surface of the carbon nanotube structure. In other embodiments, the carbon nanotube structure can be surrounded by the matrix material. The matrix materials can be selected from metal, resin, ceramic, glass and fiber.

The first electrode 1042 and the second electrode 1044 can be fixed on the surface of the heating element 1046 by conductive adhesive (not shown). The first electrode 1042 and the second electrode 1044 are made of conductive material. The shapes of the first electrode 1042 and the second electrode 1044 are not limited and can be lamellar-shaped, rod-shaped or wire-shaped. The cross sectional shape of the first electrode 1042 and the second electrode 1044 can be round, square, trapezium, triangular, or polygonal. The thickness of the first electrode 1042 and the second electrode 1044 can be any size, depending on the design, and can be about 1 micrometer to about 1 centimeter. In the present embodiment as shown in FIG. 1, the first electrode 1042 and the second electrode 1044 both have a linear shape, and are attached on the surface of the heating element 1046, and substantially parallel with an axial direction of the inner pipe 100. The first electrode 1042 and the second electrode 1044 are substantially parallel with each other. In one embodiment, if the heating element 1046 includes the carbon nanotube structure having a plurality of carbon nanotubes arranged in a same direction, the carbon nanotubes are oriented form the first electrode 1042 to the second electrode 1044.

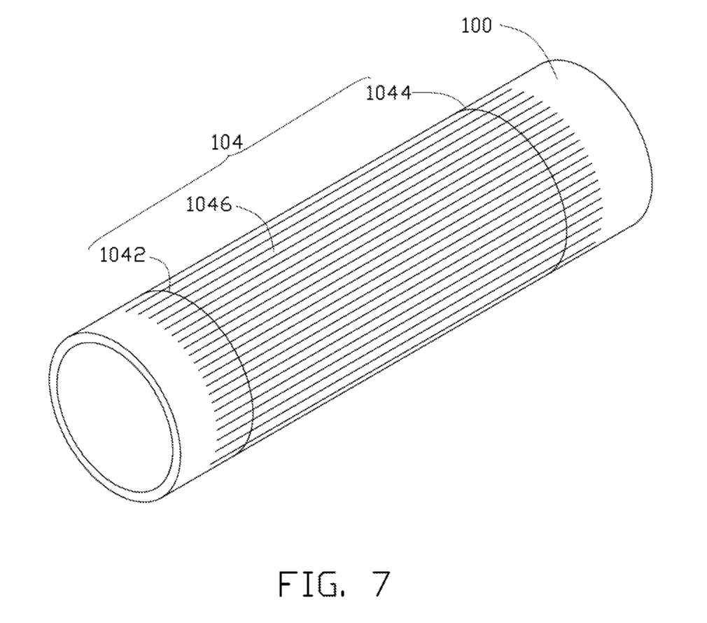

In another embodiment according to FIG. 7, the first electrode 1042 and the second electrode 1044 are separately disposed on two opposite ends of the inner pipe 100. The first electrode 1042 and the second electrode 1044 wind around the inner pipe 100 to form two ring structures. If the heating element 1046 includes the carbon nanotube structure having a plurality of carbon nanotubes arranged in a same direction, the carbon nanotubes are oriented from the first electrode 1042 to the second electrode 1044.

In other embodiments, the heating module 104 can includes a plurality of first electrodes 1042 and a plurality of second electrodes 1044. The number of the first electrodes 1042 and the number of the second electrodes 1044 can be the same. The first electrodes 1042 and the second electrodes 1044 are alternatively disposed on a surface of the heating element 1046. The carbon nanotube structure disposed between every adjacent first electrode 1042 and second electrode 1044 can be electrically connected in parallel with each other.

In one embodiment, the heating element 1046 includes a single linear carbon nanotube structure spirally twisted about the inner pipe 100, and the first electrode 1042 and the second electrode 1044 can be omitted.

The outer pipe 102 covers the heating module 104. The outer pipe 102 is configured for keeping the heating module 104 away from contamination from the surroundings, and can also protect the user from getting an electric shock when touching the fluid heater 10. An inner diameter of the outer pipe 102 is larger than an outer diameter of the inner pipe 100. Particularly, the outer pipe 102 and the inner pipe 100 are coaxial. The sealed room 120 defined by the outer pipe 102, the inner pipe 100 and the two sealed elements 110 can be in a vacuum-like state. The sealed room 120 can be used to save the heat produced by the heating element 1046. A material of outer pipe 102 can be conductive or insulative. The electrically conductive material can be metal or alloy. The metal can be copper, aluminum or titanium. The insulated material can be resin, ceramic, plastic, or wood. The resin can be acrylic, polypropylene, polycarbonate, polyethylene, epoxy resin or PTFE. The material of the outer pipe 102 can be flexible. If the materials of the inner pipe 100 and the outer pipe 102 are both flexible, the fluid heater 10 can be flexible according to determination. The thickness of the outer pipe 102 can range from about 0.5 μm to about 2 mm. If the material of the outer pipe 102 is insulative, the outer pipe 102 can be directly disposed on a surface of the heating module 104. If the outer pipe 102 is conductive, the outer pipe 102 should be insulated from the heating module 100.

The fluid heater 10 can further include a heat-reflective layer 112 disposed on the inner surface of the outer pipe 102. The heat-reflective layer 112 is disposed apart from the heating module 104. The heat-reflective layer 112 is configured to reflect back the heat emitted by the heating module 104, and control the direction of the heat emitted by the heating module 104. The material of the heat-reflective layer 112 can be selected from conductive material or insulative material. The insulative material can be metal oxides, metal salts, or ceramics. The conductive material can be silver, aluminum, gold or alloy. A thickness of the heat-reflective layer 112 can be in a range from about 100 micrometers to about 0.5 millimeters.

The fluid heater 10 can alternatively include a heat-insulated layer 130 disposed on an outer surface of the outer pipe 102. A material of the heat-insulated layer 130 can be asbestos, diatomite, perlite, glass fiber or combination thereof. The heat-insulated layer 130 is configured to aid in retaining the heat produced by the heating module 104.

In use, if a voltage is applied to the first electrode 1042 and the second electrode 1044 of the fluid heater 10 via a power wire 106, the carbon nanotube structure can radiate heat at a certain wavelength. The fluid heater 10 can further include a temperature-controlling element 108 to control the temperature of the fluid heater 10 via changing a voltage between the first electrode 1042 and the second electrode 1044. In one embodiment, the temperature-controlling element 108 is electrically connected in series with the fluid heater 10.

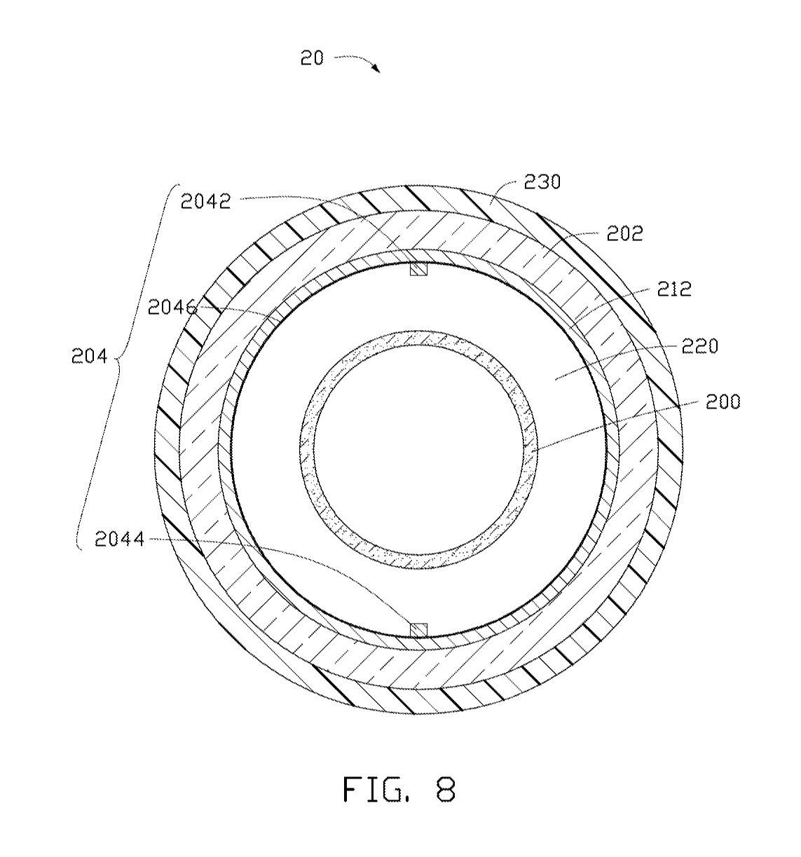

Referring to FIG. 8, a fluid heater 20 according to another embodiment includes an inner pipe 200, an outer pipe 202 surrounding the inner pipe 200, two sealed elements 210 disposed on an out surface of the inner pipe 200, and a heating module 204 located between the inner pipe 200 and the outer pipe 202. The two sealed elements 210 contact two ends of the outer pipe 202, and located between the inner pipe 200 and the outer pipe 202. A sealed room 220 is defined by the inner pipe 200, the two sealed elements 210, and the outer pipe 202. The heating module 204 includes a heating element 2046, a first electrode 2042 and a second electrode 2044. The heating element 2046 is attached to an inner surface of the outer pipe 202, and is spaced from the inner pipe 200. In some embodiments, the heating element 2046 can also be clamped between the outer pipe 202 and the inner pipe 200, and the first electrode 2042 and the second electrode 2044 can each be a layer of conductive material coated on the heating element 2046.

The fluid heater 20 further includes a heat-reflective layer 212 located on an outer surface of the heating element 2046. The material of the heat-reflective layer 212 is selected insulated material.

Other characteristics of the fluid heater 20 are the same as the fluid heater 10 disclosed above.

In use of the fluid heater disclosed in the present disclosure, a conventional fluid pipe can be directly inserted in the fluid heater, with the fluid heater encircling the conventional fluid pipe. The fluid heater is able to heat fluid flowing through the conventional fluid pipe. Because the fluid in the conventional fluid pipe does not contact the fluid heater, the fluid will not be polluted by the fluid heater, and the fluid heater will not be damaged by the fluid if the fluid has become corrosive. In addition, because the fluid heater encircles the conventional fluid pipe, the fluid heater can move freely and heat different portions of the conventional fluid pipe. Furthermore, if a stable voltage is applied to the heater, the fluid can have a stable temperature. Alternatively, the temperature of the fluid heater can be controlled by a temperature-control element controlling the heated liquid to an exact temperature.

The fluid heater disclosed in the present disclosure can be used to heat liquid or gas flowing through the fluid heater. The fluid heater can be used in many fields, such as pre-heating air in a boiler of power station to improve production efficiency, heating a pipe in different sections in a laboratory to control catalytic effect of enzymes, heating liquid medicine before it is injected into a patient to make the patient comfortable or improve the medicinal effect, and heating running water.

It is to be understood that the above-described embodiments are intended to illustrate rather than limit the present disclosure. Variations may be made to the embodiments without departing from the spirit of the disclosure as claimed. It is understood that any element of any one embodiment is considered to be disclosed to be incorporated with any other embodiment. The above-described embodiments illustrate the scope of the disclosure but do not restrict the scope of the disclosure.

What claimed is:

1. A fluid heater comprising:
an inner pipe;
an outer pipe surrounding the inner pipe and spaced from the inner pipe;
two sealed elements located apart from each other and between the inner pipe and the outer pipe, wherein the two sealed elements, the inner pipe, and the guiding pipe cooperatively define a sealed room disposed between the inner pipe and the outer pipe; and
a heating module received in the sealed room.

2. The fluid heater of claim 1, wherein the sealed room is in a vacuum-like state.

3. The fluid heater of claim 1, further comprising a heat-reflective layer located between the heating module and the outer pipe.

4. The fluid heater of claim 3, wherein the heat-reflective layer is located on an inner surface of the outer pipe.

5. The fluid heater of claim 3, wherein the heating module is attached on the outer surface of the inner pipe and apart from the heat-reflective layer.

6. The fluid heater of claim 3, wherein the heat-reflective layer is made of insulative material and positioned on a surface of the heating module.

7. The fluid heater of claim 1, wherein the heating module comprises a heating element, a first electrode, and a second electrode, the first electrode and the second electrode being electrically connected with the heating element.

8. The fluid heater of claim 7, wherein the heating element comprises a freestanding carbon nanotube structure comprising a plurality of carbon nanotubes joined by Van der Waals attractive force.

9. The fluid heater of claim 8, wherein the carbon nanotube structure comprises at least one carbon nanotube film wrapping the outer surface of the inner pipe.

10. The fluid heater of claim 9, wherein the at least one carbon nanotube film comprises a plurality of carbon nanotubes joined end-to-end with each other and oriented in a substantially same direction.

11. The fluid heater of claim 10, wherein the first electrode and the second electrode both have wire structures and are parallel with an axial direction of the inner pipe.

12. The fluid heater of claim 11, wherein the carbon nanotubes in the carbon nanotube film are oriented from the first electrode to the second electrode.

13. The fluid heater of claim 10, wherein the first electrode and the second electrode each have a ring structure and are wound around two opposite ends of the inner pipe, and the carbon nanotubes in the carbon nanotube film are oriented from the first electrode to the second electrode.

14. The fluid heater of claim 7, wherein the carbon nanotube structure comprises at least one linear carbon nanotube structure attached on the outer surface of the inner pipe.

15. A fluid heater comprising:
an inner pipe;
an outer pipe surrounding the inner pipe and located apart from the inner pipe;
two sealed elements located apart from each other and between the inner pipe and the outer pipe;
a sealed room defined by the inner pipe, the outer pipe, and the two sealed elements; and
a heating module located in the sealed room, the heating module comprising a heating element comprising a carbon nanotube structure surrounding the inner pipe.

16. The fluid heater of claim 15, wherein a heat capacity per unit area of the carbon nanotube structure is less than 2×10⁻⁴ J/m²*K.

17. The fluid heater of claim 15, wherein the carbon nanotube structure comprises one linear carbon nanotube structure twisted around an outer surface of the inner pipe.

18. The fluid heater of claim 15, wherein the carbon nanotube structure comprises a plurality of linear carbon nanotube structures located side by side and substantially parallel with each other on an outer surface of inner pipe.

19. The fluid heater of claim 15, wherein the carbon nanotube structure comprises a plurality of linear carbon nanotube structures knitted to obtain a net structure located on an outer surface of the inner pipe.

20. A method for heating fluid, comprising:
providing a fluid heater, the fluid heater comprising an inner pipe, an outer pipe surrounding the inner pipe and spaced apart from the inner pipe, a sealed room defined by an outer surface of the inner pipe and an inner surface of the inner pipe, and a heating module received in the sealed room; and
installing a fluid supplying pipe into the inner pipe of the fluid heater with an outer surface of the fluid supplying pipe thermally communicating with the inner pipe.
